(19) United States
(12) Patent Application Publication
(10) Pub. No.: US 2025/0326059 A1
(43) Pub. Date: Oct. 23, 2025

(54) METHOD OF MANUFACTURING JOINED BODY

(71) Applicant: FUTABA INDUSTRIAL CO., LTD., Okazaki-shi (JP)

(72) Inventor: Yuta FUJIKASA, Okazaki-shi (JP)

(21) Appl. No.: 19/093,572

(22) Filed: Mar. 28, 2025

(30) Foreign Application Priority Data
Apr. 19, 2024 (JP) 2024-068429

(51) Int. Cl. B23K 26/244; B23K 35/30; B23K 103/20

(52) U.S. Cl. CPC B23K 26/244; B23K 35/3046; B23K 2103/20

(57) ABSTRACT

A method of manufacturing a joined body formed by welding using a deposit metal member includes irradiating the deposit metal member with a laser light to form a joint portion that joins an iron-based metal member and an aluminum-based metal member by the deposit metal member that is melted. The joint portion is formed so as to lie astride a first joint surface of the iron-based metal member and a second joint surface of the aluminum-based metal member. A short-wavelength laser light with a wavelength of 600 nm or less is used as the laser light.

### CROSS-REFERENCE TO RELATED APPLICATIONS

This application claims the benefit of Japanese Patent Application No. 2024-068429 filed on Apr. 19, 2024 with the Japan Patent Office, and the entire content of Japanese Patent Application No. 2024-068429 is incorporated herein by reference.

### BACKGROUND

The present disclosure relates to a method of manufacturing a joined body.

It is known that, when an iron-based metal member and an aluminum-based metal member are directly welded in order to form a composite material of the iron-based metal member and the aluminum-based metal member, a brittle intermetallic compound is generated at a joint portion therebetween.

Japanese Unexamined Patent Application Publication No. 2021-167013 discloses a method of controlling formation of a brittle intermetallic compound by forming a deposit metal part that joins an iron-based metal member and an aluminum-based metal member to each other by MIG welding using a filler material that is an alloy containing nickel and copper, with a nickel content of 30 to 80% by mass. The deposit metal part contains nickel, copper, iron, and aluminum in specific proportions in a center part thereof.

### SUMMARY

However, when the deposit metal part is formed as described in Japanese Unexamined Patent Application Publication No. 2021-167013, in a case of welding using, for example, a near-infrared laser with a large heat input, the aluminum-based metal member is also easily heated simultaneously when the filler material is melted. Since aluminum has a melting point lower than nickel or copper, if the aluminum-based metal member is heated simultaneously during the melting of the filler material, aluminum is easily melted out of the aluminum-based metal member. Therefore, there is a problem in that, depending on the amount of heat input at the time of melting, the melted aluminum and iron are easily mixed together, resulting in formation of a brittle intermetallic compound.

An object of one aspect of the present disclosure is to provide a technique for inhibiting formation of a brittle intermetallic compound that is easily generated when welding an iron-based metal member and an aluminum-based metal member to each other.

According to one aspect of the present disclosure, a method of manufacturing a joined body formed by welding using a deposit metal member comprises irradiating the deposit metal member with a laser light to form a joint portion that joins an iron-based metal member and an aluminum-based metal member to each other by the deposit metal member that is melted. The joint portion is formed so as to lie astride a first joint surface of the iron-based metal member and a second joint surface of the aluminum-based metal member. A short-wavelength laser light with a wavelength of 600 nm or less is used as the laser light.

The short-wavelength laser light tends to exhibit a high absorption rate for metals that are commonly used as the deposit metal member, but a low absorption rate for aluminum. Thus, with the configuration as described above, when the deposit metal member is melted using irradiation of the short-wavelength laser light, the aluminum-based metal member is less likely to heat simultaneously, and as a result, aluminum is less likely to be melted out of the aluminum-based metal member. Therefore, it is possible to inhibit formation of a brittle intermetallic compound that tends to be generated when welding the iron-based metal member and the aluminum-based metal member to each other.

According to one aspect of the present disclosure, the deposit metal member may be a copper-based metal member.

Copper has a high absorption rate for the short-wavelength laser light. Thus, the configuration described above enables the copper-based metal member to be stably melted.

According to one aspect of the present disclosure, a near-infrared laser light with a wavelength in a near-infrared region may be used, in addition to the short-wavelength laser light, as the laser light.

With such a configuration, the deposit metal member is melted by the short-wavelength laser light, and a molten state of the deposit metal member is easily maintained by the near-infrared laser light. Accordingly, the deposit metal member in the molten state easily spreads out on the respective joint surfaces of the iron-based metal member and the aluminum-based metal member. Therefore, the iron-based metal member and the aluminum-based metal member can be joined more firmly.

### BRIEF DESCRIPTION OF THE DRAWINGS

An example embodiment of the present disclosure will be described hereinafter with reference to the accompanying drawings, in which:

FIG. 1 is a side view schematically illustrating a joined body;

FIG. 2 is a diagram for explaining a method of manufacturing the joined body; and

FIG. 3 is a diagram illustrating a relationship between wavelengths of laser light and absorption rates of the laser light in metal materials.

### DETAILED DESCRIPTION OF EXEMPLARY EMBODIMENTS

### 1. Configuration

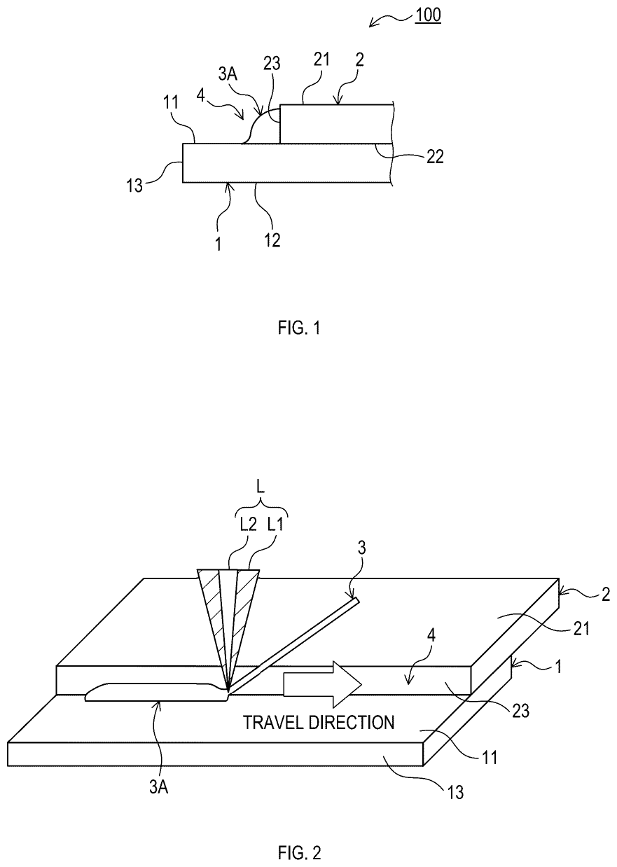

A joined body 100 shown in FIG. 1 is a composite material of an iron-based metal member 1 and an aluminum-based metal member 2, which are two joined metal members of different materials. As described in detail below, the joined body 100 is formed by welding using a deposit metal member 3. The joined body 100 comprises the iron-based metal member 1, the aluminum-based metal member 2, and a joint portion 3A.

As shown in FIG. 1 and FIG. 2, in the present embodiment, the iron-based metal member 1 and the aluminum-based metal member 2 are each, as an example, a rectangular flat plate-like member. The iron-based metal member 1 is made of a metal (in other words, iron or iron alloy), of which primary component is iron. The aluminum-based metal member 2 is made of a metal (in other words, aluminum or aluminum alloy), of which primary component is aluminum. The iron-based metal member 1 and the aluminum-based metal member 2 may have the same plate thickness or different plate thicknesses from each other.

In the following description, the iron-based metal member 1 has two opposite surfaces in its thickness direction, which are referred to as an upper surface 11 and a lower surface 12. The aluminum-based metal member 2 has two opposite surfaces in its thickness direction, which are referred to as an upper surface 21 and a lower surface 22. A surface of the iron-based metal member 1 positioned between an edge of the upper surface 11 and an edge of the lower surface 12 is referred to as an end face 13. A surface of the aluminum-based metal member 2 positioned between an edge of the upper surface 21 and an edge of the lower surface 22 is referred to as an end face 23.

In the present embodiment, the joined body 100 is configured such that the aluminum-based metal member 2 is placed above the iron-based metal member 1 in an overlapping manner. Specifically, in a state in which the end face 13 of the iron-based metal member 1 and the end face 23 of the aluminum-based metal member 2 are offset, the iron-based metal member 1 and the aluminum-based metal member 2 overlap. In examples shown in FIG. 1 and FIG. 2, the upper surface 11 of the iron-based metal member 1 and the lower surface 22 of the aluminum-based metal member 2 are in contact with each other such that a portion of the upper surface 11 of the iron-based metal member 1 is covered by the aluminum-based metal member 2. Thus, a step portion 4 is formed between the iron-based metal member 1 and the aluminum-based metal member 2.

It is noted that the joined body may be configured such that the iron-based metal member 1 is placed above the aluminum-based metal member 2 in an overlapping manner. In this case, the upper surface 21 of the aluminum-based metal member 2 and the lower surface 12 of the iron-based metal member 1 are in contact with each other such that a portion of the upper surface 21 of the aluminum-based metal member 2 is covered by the iron-based metal member 1. Thus, a step portion where a joint portion is to be formed may be formed between the iron-based metal member 1 and the aluminum-based metal member 2.

The joint portion 3A is a portion formed by melting the deposit metal member 3 using irradiation of a laser light L to join the iron-based metal member 1 and the aluminum-based metal member 2 to each other. In the present embodiment, the joint portion 3A is formed in the step portion 4. Specifically, the joint portion 3A is formed in the step portion 4 so as to lie astride the upper surface 11 of the iron-based metal member 1 and the end face 23 of the aluminum-based metal member 2.

In the present embodiment, the deposit metal member 3 is a copper-based metal member made of a metal (in other words, copper or copper alloy), of which primary component is copper.

### 2. Method of Manufacturing Joined Body

Next, a method of manufacturing the joined body 100 will be described with reference to FIG. 2.

First, the iron-based metal member 1 and the aluminum-based metal member 2 are overlapped. Specifically, the lower surface 22 of the aluminum-based metal member 2 is brought into contact with a portion of the upper surface 11 of the iron-based metal member 1 so that the step portion 4 is formed.

Next, the iron-based metal member 1 and the aluminum-based metal member 2 are welded using the deposit metal member 3. Specifically, the deposit metal member 3 is irradiated with the laser light L, and the joint portion 3A is formed in the step portion 4 by the melted deposit metal member 3. In the present embodiment, the joint portion 3A is formed so as to extend along the step portion 4 by irradiating the deposit metal member 3 with the laser light L to melt while scanning with the laser light L in a travel direction shown in FIG. 2. Thus, the joined body 100 composed of the iron-based metal member 1 and the aluminum-based metal member 2 joined to each other is manufactured.

In the present embodiment, laser lights in two different wavelength bands are used together as the laser light L. Specifically, a short-wavelength laser light L1 with a wavelength of 600 nm or less and a near-infrared laser light L2 with a wavelength in a near-infrared region are used as the laser light L. The wavelength of the short-wavelength laser light L1 is preferably 550 nm or less. The wavelength of the short-wavelength laser light L1 is more preferably 430 nm or more and 550 nm or less. The wavelength of the near-infrared laser light L2 is preferably 750 nm or more. The wavelength of the near-infrared laser light L2 is more preferably 780 nm or more and 1700 nm or less. As an example, the wavelength of the near-infrared laser light L2 may be 1070 nm.

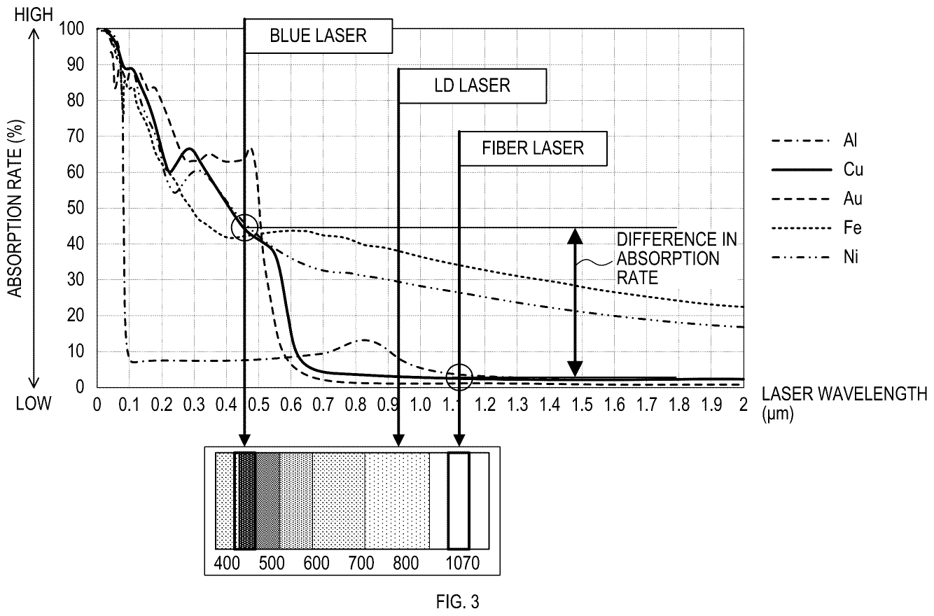

As shown in FIG. 3, which is an illustration described on a homepage of UW JAPAN Co., Ltd., a light of, for example, a fiber laser, which is included in the wavelength band (i.e., the near-infrared region) of the near-infrared laser light L2, exhibits a lower absorption rate for copper than aluminum. Accordingly, melting the deposit metal member 3 using the near-infrared laser light L2 requires a large heat input. Therefore, when the deposit metal member 3 is melted using the near-infrared laser light L2, the aluminum-based metal member 2 is easily heated simultaneously, and aluminum is easily melted out of the aluminum-based metal member 2 since a melting point of aluminum is lower than that of copper. Therefore, when the iron-based metal member 1 and the aluminum-based metal member 2 are welded, a brittle metallic compound formed by mixing the melted aluminum and iron tends to be generated.

In addition, in a case in which the near-infrared laser light L2 exhibits a low absorption rate on the deposit metal member 3, the heat input to the deposit metal member 3 is less likely to be stable, thus making it less likely to obtain a stable molten state. As described, in a case in which the melting of the deposit metal member 3 is less likely to be stable, a variation in the size of a molten pool tends to increase. Accordingly, in a case in which the near-infrared laser light L2 is used to form the joint portion 3A, the melting of the deposit metal member 3 is less likely to be stable, which results in difficulty in obtaining stable welding quality. As described above, when the near-infrared laser light L2 alone is used to weld the iron-based metal member 1 and the aluminum-based metal member 2 to each other, the above-described problem tends to occur.

On the other hand, a light of, for example, blue laser, which is included in the wavelength band of the short-wavelength laser light L1, exhibits a high absorption rate for copper, but a low absorption rate for aluminum. Thus, the deposit metal member 3 is easily heated using irradiation of the short-wavelength laser light L1, whereas the aluminum-based metal member 2 is less likely to be heated. That is, when the deposit metal member 3 is melted, the aluminum-based metal member 2 is less likely to heat simultaneously, which results in less aluminum melting out of the aluminum-based metal member 2. Therefore, when the iron-based metal member 1 and the aluminum-based metal member 2 are welded, a brittle metallic compound is less likely to be generated.

In addition, in a case in which the short-wavelength laser light LI exhibits a high absorption rate on the deposit metal member 3, since the heat input to the deposit metal member 3 tends to be stable, the stable molten state is easily obtained. As described, in a case in which the melting of the deposit metal member 3 tends to be stable, the variation of the size of the molten pool tends to be small. Accordingly, in a case in which the short-wavelength laser light L1 is used to form the joint portion 3A, the melting of the deposit metal member 3 tends to be stable, which results in easily obtaining the stable welding quality.

That is, using the short-wavelength laser light L1 to weld the iron-based metal member 1 and the aluminum-based metal member 2 to each other makes it possible to provide the stable welding quality while inhibiting formation of the brittle metallic compound.

Furthermore, as in the present embodiment, in a case in which the near-infrared laser light L2 is used together with the short-wavelength laser light L1, in addition to obtaining the above-described effect from the short-wavelength laser light L1, it is easy to maintain a molten state of the melted deposit metal member 3 with the near-infrared laser light L2. Accordingly, the deposit metal member 3 in the molten state can easily spread out in the step portion 4, and as a result, the joint between the iron-based metal member 1 and the aluminum-based metal member 2 tends to be stronger.

The short-wavelength laser light L1 and the near-infrared laser light L2 may be radiated from the same head so as to be coaxial, or may be radiated from different heads so as to have different axes from each other. In addition, the short-wavelength laser light L1 and the near-infrared laser light L2 may be radiated at the same timing, or may be radiated at different timings in the order of the short-wavelength laser light L1 and then the near-infrared laser light L2.

### 3. Effects

According to the embodiment detailed above, the following effects can be obtained.

(3a) In the present embodiment, the short-wavelength laser light L1 is used in the welding of the iron-based metal member 1 and the aluminum-based metal member 2 using the deposit metal member 3 that is a copper-based metal member. As described above, the short-wavelength laser light L1 exhibits a high absorption rate for copper, but a low absorption rate for aluminum. Thus, when the deposit metal member 3 is melted using irradiation of the short-wavelength laser light L1, the aluminum-based metal member 2 is less likely to heat simultaneously, and as a result, aluminum is less likely to be melted out of the aluminum-based metal member 2. Therefore, it is possible to inhibit formation of a brittle intermetallic compound that tends be generated when welding the iron-based metal member 1 and the aluminum-based metal member 2.

(3b) In the present embodiment, the copper-based metal member is used as the deposit metal member 3. As described above, since the short-wavelength laser light L1 exhibits a high absorption rate for copper, the deposit metal member 3 can be stably melted. Consequently, the stable welding quality is easily obtained.

(3c) In the present embodiment, to weld the iron-based metal member 1 and the aluminum-based metal member 2 to each other, the near-infrared laser light L2 is used in addition to the short-wavelength laser light L1. Thus, the deposit metal member 3 is melted by the short-wavelength laser light L1, and the molten state of the deposit metal member 3 is easily maintained by the near-infrared laser light L2. Accordingly, the deposit metal member 3 in the molten state easily spreads out on the upper surface 11 and the end face 23 (i.e., the step portion 4), which are the respective joint surfaces of the iron-based metal member 1 and the aluminum-based metal member 2. Therefore, the iron-based metal member 1 and the aluminum-based metal member 2 can be joined more firmly.

It is to be noted that, in the present embodiment, the upper surface 11 of the iron-based metal member 1 corresponds to an example of a first joint surface, and the end face 23 of the aluminum-based metal member 2 corresponds to an example of a second joint surface.

### 4. Other Embodiments

The embodiment of the present disclosure has been described above. However, the present disclosure is not limited to the above-described embodiment, and may take various forms.

(4a) In the above-described embodiment, as an example, the configuration in which the deposit metal member 3 is a copper-based metal member is described, but a metal material constituting the deposit metal member is not limited to copper. For example, the deposit metal member may be made of a metal (in other words, silver or silver alloy), of which primary component is silver, or a metal (in other words, gold or gold alloy), of which primary component is gold. As shown in FIG. 3, gold also has a high absorption rate for the short-wavelength laser light L1. In addition, although not shown in FIG. 3, silver also has a high absorption rate for the short-wavelength laser light L1, similarly to copper and gold. Thus, also in a case in which the deposit metal member is a silver-based metal member or a gold-based metal member, effects similar to those of the copper-based metal member can be obtained.

(4b) In the above-described embodiment, the near-infrared laser light L2 is used, in addition to the short-wavelength laser light L1, as the laser light L, but, for example, the short-wavelength laser light L1 alone may be used as the laser light L.

(4c) In the above-described embodiment, as an example, the joined body 100 is described, which is manufactured by forming the joint portion 3A in the step portion 4 formed by the overlap of the iron-based metal member 1 and the aluminum-based metal member 2. However, the shape of the joined body and the location where the joint portion is formed are not limited thereto. For example, the joined body may be manufactured by bringing the iron-based metal member 1 and the aluminum-based metal member 2 into contact with each other at the end faces 13, 23, and forming the joint portion at the portions in contact with each other so that the joint portion lies astride the upper surface 11 of the iron-based metal member 1 and the upper surface 21 of the aluminum-based metal member 2. Alternatively, for example, the joined body may be manufactured by arranging the iron-based metal member and the aluminum-based metal member so that portions of the respective upper surfaces face each other, and forming the joint portion at the portions facing each other so that the joint portion lies astride the respective upper surfaces.

(4d) A function of one element in the above-described embodiments may be distributed as two or more elements, or functions of two or more elements may be integrated into one element. Part of the configuration of the above-described embodiments may be omitted. At least part of the configuration of the above-described embodiment may be added to or replace the configuration of the above-described different embodiment.

What is claimed is:

1. A method of manufacturing a joined body formed by welding using a deposit metal member, the method comprising:
irradiating the deposit metal member with a laser light to form a joint portion that joins an iron-based metal member and an aluminum-based metal member to each other by the deposit metal member that is melted, wherein
the joint portion is formed so as to lie astride a first joint surface of the iron-based metal member and a second joint surface of the aluminum-based metal member, and
a short-wavelength laser light with a wavelength of 600 nm or less is used as the laser light.

2. The method of manufacturing a joined body according to claim 1, wherein the deposit metal member is a copper-based metal member.

3. The method of manufacturing a joined body according to claim 1, wherein
a near-infrared laser light with a wavelength in a near-infrared region is used, in addition to the short-wavelength laser light, as the laser light.

4. The method of manufacturing a joined body according to claim 2, wherein
a near-infrared laser light with a wavelength in a near-infrared region is used, in addition to the short-wavelength laser light, as the laser light.
